(19) United States
(12) Patent Application Publication
(10) Pub. No.: US 2025/0232520 A1
(43) Pub. Date: Jul. 17, 2025

(54) IMAGE GENERATION APPARATUS, IMAGE GENERATION METHOD, AND PROGRAM

(71) Applicant: NEC Corporation, Tokyo (JP)

(72) Inventor: Tsubasa NAKAMURA, Tokyo (JP)

(73) Assignee: NEC Corporation, Tokyo (JP)

(21) Appl. No.: 18/968,025

(22) Filed: Dec. 4, 2024

(30) Foreign Application Priority Data
Jan. 12, 2024 (JP) 2024-003243

(51) Int. Cl. G06T 15/20; G06T 15/50

(52) U.S. Cl. CPC G06T 15/20; G06T 15/506; G06T 2200/24

(57) ABSTRACT

An image generation apparatus generates a free-viewpoint two-dimensional image of a three-dimensional scene, a spatial structure and information on optics of which have been trained and comprises a pre-trained optical training/inference part and a reflection azimuth calculator, wherein the optical training/inference part receives azimuth information and extracts optical information by utilizing at least the azimuth information, and the reflection azimuth calculator receives an angle control parameter as an input, performs a calculation of an observation azimuth and the angle control parameter to at least a partial region within a reconstructed space based on the trained spatial structure to generate the azimuth information, and outputs the azimuth information to the optical training/inference part.

### FIELD

### REFERENCE TO RELATED APPLICATION

The present invention is based upon and claims the benefit of the priority of Japanese patent application No. 2024-003243 filed on Jan. 12, 2024, the disclosure of which is incorporated herein in its entirety by reference thereto.

The present invention relates to an image generation apparatus, an image generation method, and a program.

### BACKGROUND

The following literature can be listed regarding displaying a two-dimensional image of a three-dimensional scene:

Patent Literature (PTL) 1 relates to an image processing apparatus that performs three-dimensional modeling using machine learning.

[PTL 1] Japanese Patent Kokai Publication No. 2023-66705 A

### SUMMARY

The following analysis is given by the present inventor.

Neural Radiance Fields (NeRF), a training-based three-dimensional modeling technology, is rapidly gaining traction across a wide range of fields that deal with three-dimensional (3D) shapes. In NeRF, a two-dimensional image of a three-dimensional scene shot by using a camera is inputted as a teacher image, and for example, a shooting environment for the teacher images, such as the position of lighting in a three-dimensional space during the shooting, typically remains fixed.

Moreover, because setting up a shooting environment, such as arranging the lighting or camera angles, can be time-consuming, it makes difficult to set a shooting environment again to perform a reshoot. As a result, an expert such as a professional photographer is often required.

It is an object of the present invention to provide an image generation apparatus, an image generation method, and a program that contribute to enabling control of a lighting environment and luster in a two-dimensional image when generating a free-viewpoint two-dimensional image of a three-dimensional scene after teacher images have been shot in a fixed lighting environment.

According to a first aspect of the present invention, there can be provided an image generation apparatus, generating a free-viewpoint two-dimensional image of a three-dimensional scene, a spatial structure and information on optics of which have been trained, the image generation apparatus comprising:
a pre-trained optical training/inference part; and
a reflection azimuth calculator, wherein
the optical training/inference part receives azimuth information and extracts optical information by utilizing at least the azimuth information, and
the reflection azimuth calculator receives an angle control parameter as an input, performs a calculation of an observation azimuth and the angle control parameter to at least a partial region within a reconstructed space based on the trained spatial structure to generate the azimuth information, and outputs the azimuth information to the optical training/inference part.

According to a second aspect of the present invention, there can be provided an image generation method performed by a computer of an image generation apparatus that generates a free-viewpoint two-dimensional image of a three-dimensional scene, a spatial structure and information on optics of which have been trained, comprising:
receiving azimuth information and extracting optical information by utilizing at least the azimuth information through a pre-trained optical training/inference part;
receiving an angle control parameter as an input; and
performing a calculation of an observation azimuth and the angle control parameter to at least a partial region within a reconstructed space based on the trained spatial structure to generate the azimuth information. The present method is tied to a particular machine, namely a computer that executes the method described above.

According to a third aspect of the present invention, there can be provided a program, causing a computer of an image generation apparatus that generates a free-viewpoint two-dimensional image of a three-dimensional scene, a spatial structure and information on optics of which have been trained, to execute processings of: receiving azimuth information and extracting optical information by utilizing at least the azimuth information through a pre-trained optical training/inference part; receiving an angle control parameter as an input; and performing a calculation of an observation azimuth and the angle control parameter to at least a partial region within a reconstructed space based on the trained spatial structure to generate the azimuth information.

Further, the program(s) can be stored in a computer-readable storage medium. The storage medium may be a non-transitory one such as a semiconductor memory, a hard disk, a magnetic recording medium, an optical recording medium, and the like. The present invention can also be realized as a computer program product.

According to the present invention, there can be provided an image generation apparatus, image generation method, and program that contribute to enabling control of a lighting environment and luster in a two-dimensional image when generating a free-viewpoint two-dimensional image of a three-dimensional scene after teacher images have been shot in a fixed lighting environment.

### BRIEF DESCRIPTION OF DRAWINGS

FIG. 1 is a block diagram illustrating an example of a configuration of an image generation apparatus relating to the present disclosure.

FIG. 2 is a block diagram illustrating an example of a configuration of a conventional image generation system.

FIG. 3 is a block diagram illustrating an example of a configuration of an image generation system relating to the present disclosure.

FIG. 4 is a block diagram illustrating an example of a configuration of an image generation system relating to the present disclosure.

FIG. 5 is a drawing illustrating an example of a configuration of an input screen of an angle control parameter input section of a GUI input part of an image generation apparatus relating to the present disclosure.

FIG. 6 is a drawing illustrating an example of a configuration of an input screen of an angle control parameter input section of a GUI input part of an image generation apparatus relating to the present disclosure.

FIG. 7 is a drawing illustrating an example of a configuration of an input screen of an angle control parameter input section of a GUI input part of an image generation apparatus relating to the present disclosure.

FIG. 8 is a drawing schematically illustrating an example of information obtained by an optical training/inference section relating to the present disclosure.

FIG. 9 is a drawing schematically illustrating an example of a method for shooting a teacher image relating to the present disclosure.

FIG. 10 is a drawing illustrating a configuration of a computer that makes up an image generation apparatus relating to the present disclosure.

### EXAMPLE EMBODIMENTS

It should be noted that the drawings in the present disclosure may relate to one or more example embodiments. Further, each example embodiment described below can be combined with another example embodiment as appropriate, and the present invention is not limited to these example embodiments.

First, the following describes an outline of an example embodiment with reference to the drawings. It should be noted that the drawing reference signs in the outline are given to each element for convenience as an example to facilitate understanding and are not intended to limit the present invention to the illustrated modes. Further, connection lines between blocks in the drawings referred to in the following description can be both bidirectional and unidirectional. A unidirectional arrow schematically shows a flow of a main signal (data) and does not exclude bidirectionality.

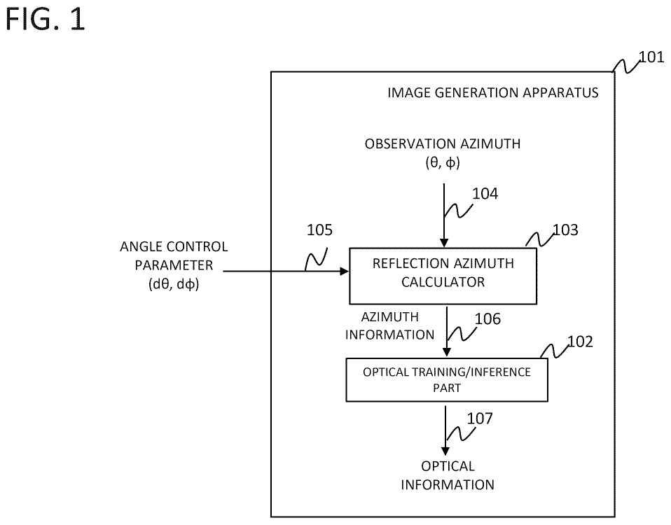

FIG. 1 is a block diagram illustrating an example of a configuration of an image generation apparatus relating to the present disclosure. With reference to FIG. 1, the image generation apparatus 101 generates a free-viewpoint two-dimensional image of a three-dimensional scene, a spatial structure and information on optics of which have been trained. The image generation apparatus 101 includes a pre-trained optical training/inference part 102 and a reflection azimuth calculator 103.

The optical training/inference part 102 receives azimuth information 106 and extracts optical information 107 by utilizing at least the azimuth information 106.

The reflection azimuth calculator 103 receives an angle control parameter 105 as an input and performs a calculation of an observation azimuth 104 and the angle control parameter 105 to at least a partial region within a reconstructed space based on the trained spatial structure to generate the azimuth information 106. Then, the reflection azimuth calculator 103 outputs the azimuth information 106 to the optical training/inference part 102.

When a free-viewpoint two-dimensional image of a three-dimensional scene is generated, a lighting environment and luster in the two-dimensional image can be changed by varying the angle control parameter 105 supplied to the reflection azimuth calculator 103.

This is because, by supplying the azimuth information 106 obtained by performing a calculation of the observation azimuth 104 and the angle control parameter 105 to the pre-trained optical training/inference part 102, a viewpoint for generating a free-viewpoint two-dimensional image, i.e., a reflected light when viewed from a different azimuth relative to the free viewpoint, that is, the optical information 107 or RGB values can be extracted from the pre-trained optical training/inference part 102.

Therefore, according to the example embodiment, there can be provided an image generation apparatus, an image generation method, and a program that contribute to enabling control of a lighting environment and luster in a two-dimensional image when generating a free-viewpoint two-dimensional image of a three-dimensional scene after teacher images have been shot in a fixed lighting environment.

### First Example Embodiment

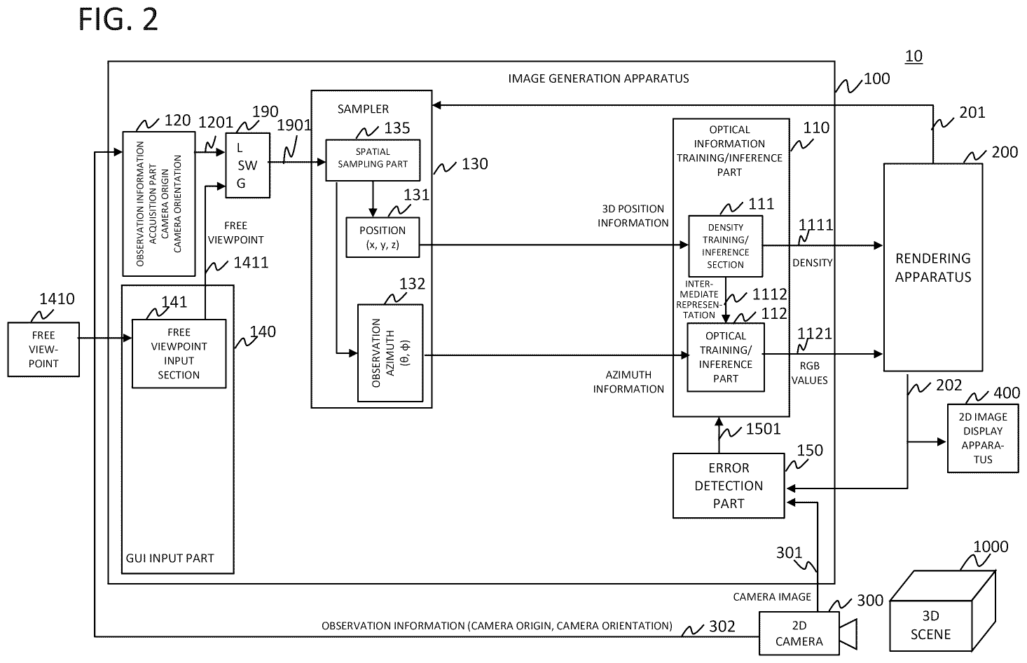

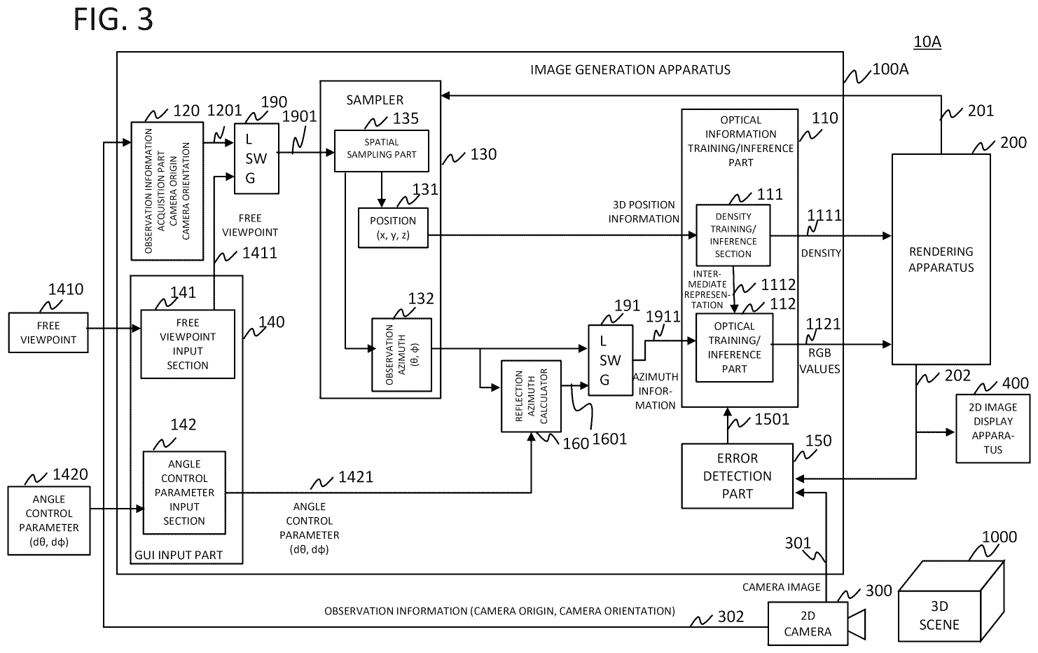

Next, a first example embodiment will be described in detail with reference to the drawings. FIG. 3 is a block diagram illustrating an example of a configuration of an image generation System relating to the present disclosure. Further, FIG. 2 is a block diagram illustrating an example of a configuration of a conventional image generation system. With reference to FIG. 2, the conventional image generation system 10 includes an image generation apparatus 100, a rendering apparatus 200, a two-dimensional camera (also referred to as a sensor) 300, and a two-dimensional image display apparatus 400. The two-dimensional camera 300 acquires a two-dimensional image of a three-dimensional scene 1000.

First, the following describes an example of an operation of the conventional image generation system 10 during training and inference. During training of the conventional image generation system 10, the image generation apparatus 100 uses an optical information training/inference part 110 and an error detection part 150 to train a spatial structure and information on optics using a two-dimensional image of a three-dimensional scene acquired by the two-dimensional camera 300 as teacher data. Note that, although the two-dimensional camera 300 is connected to the error detection part 150 by a line, the two-dimensional camera 300 and the error detection part 150 do not need to be directly connected to each other, and it is sufficient if an image shot by the two-dimensional camera 300 is supplied to the error detection part 150.

### (1) Operation of the Conventional Image Generation System 10 During Training

First, an example of an operation of the conventional image generation system 10 during training will be described. During training, a two-dimensional image (also referred to as a camera image) 301 obtained by shooting the three-dimensional scene 1000 by the two-dimensional camera 300 is inputted to the error detection part 150 as a teacher image. Further, observation information 302 regarding how the two-dimensional image 301 was shot, such as a camera origin or camera orientation, is supplied to an observation information acquisition part 120. The observation information 302 supplied to the observation information acquisition part 120 is outputted from the observation information acquisition part 120 to an L input of a switch (also referred to as an SW) 190 as an observation viewpoint 1201. Note that the switch 190 outputs information supplied to the L input as an output 1901 during training and outputs information supplied to a G input thereof as the output 1901 during inference. Therefore, during training, the switch 190 outputs the observation information 302 supplied to the L input to a spatial sampling part 135 of a sampler 130 as the output 1901. Note that the switch 190 does not have to be an actual switch as long as it is configured to provide the spatial sampling part 135 with the observation viewpoint 1201, which is supplied to the L input, as the output 1901 during training and provide the spatial sampling part 135 with a free viewpoint 1411 outputted by a free viewpoint input section 141 as the output 1901 during inference.

The rendering apparatus 200 sends information 201 regarding pixels to be rendered (also referred to as volume-rendered) to the sampler 130, and the spatial sampling part 135 generates a position (x, y, z) 131 and an observation azimuth (θ, φ) 132 required to generate a pixel of a two-dimensional image 202 corresponding to the information 201 regarding pixels to output the position (x, y, z) 131 to a density training/inference section 111 of the optical information training/inference part 110 as three-dimensional position information and output the observation azimuth (θ, φ) 132 to an optical training/inference part 112 of the optical information training/inference part 110 as azimuth information. Further, the density training/inference section 111 outputs an intermediate representation 1112 to the optical training/inference part 112. Note that the density training/inference section 111 is a subordinate concept of an intermediate representation training/inference part that trains and infers an intermediate representation and may have any configuration as long as it is configured to output the intermediate representation 1112. Further, it is also possible to use a configuration in which the position 131 and the observation azimuth 132 outputted by the sampler 130 are converted into a position-embedded representation and an azimuth-embedded representation. In this case, the same configuration is assumed to be used during inference.

The density training/inference section 111 uses the position (x, y, z) 131 to generate a density 1111 and outputs the density 1111 to the rendering apparatus 200. Further, the optical training/inference part 112 uses the observation azimuth (θ, φ) 132 and the intermediate representation 1112 to generate RGB values 1121 and outputs the RGB values 1121 to the rendering apparatus 200.

The rendering apparatus 200 uses the density 1111 and the RGB values 1121 to generate a pixel of the two-dimensional image 202 corresponding to the information 201 regarding pixels. In this manner, all pixels of the two-dimensional image 202 are generated, and the two-dimensional image 202 is rendered and outputted. The rendered two-dimensional image 202 is sent to the two-dimensional image display apparatus 400 and the error detection part 150.

The error detection part 150 detects an error between the two-dimensional image 202 rendered by the rendering apparatus 200 and the two-dimensional image 301 of the three-dimensional scene acquired by the two-dimensional camera 300. On the basis of an error 1501 outputted by the error detection part 150, the optical information training/inference part 110 adjusts parameters of the density training/inference section 111 and parameters of the optical training/inference part 112 to generate a trained model. Note that the density training/inference section 111 and the optical training/inference part 112 may include a neural network. Further, the parameters of the density training/inference section 111 and the optical training/inference part 112 may be adjusted by adjusting a parameter of a neural network included in the density training/inference section 111 and the optical training/inference part 112. The generated trained model includes a first trained model within the density training/inference section 111 and a second trained model within the optical training/inference part 112.

### (2) Operation of the Conventional Image Generation System 10 During Inference

Next, the following describes an example of an operation of the conventional image generation system 10 during inference, i.e., an operation when a free-viewpoint two-dimensional image of the three-dimensional scene 1000 is generated. During inference of the conventional image generation system 10, as an example, a user enters a free viewpoint 1410 as the user's observation viewpoint for the three-dimensional scene 1000 into, for instance, the free viewpoint input section 141 of a GUI (Graphic User Interface) input part 140 of the image generation system 10. The free viewpoint 1410 supplied to the free viewpoint input section 141 is outputted from the free viewpoint input section 141 to the G input of the switch 190 as a free viewpoint 1411. During inference, the switch 190 outputs the free viewpoint 1411 supplied to the G input to the spatial sampling part 135 of the sampler 130 as the output 1901. Note that the free viewpoint 1411 is the same as the free viewpoint 1410.

The rendering apparatus 200 sends information 201 regarding pixels to be rendered to the sampler 130, and the spatial sampling part 135 generates a position (x, y, z) 131 and an observation azimuth (θ, φ) 132 required to generate a pixel of a two-dimensional image 202 corresponding to the information 201 regarding pixels.

Next, the spatial sampling part 135 of the sampler 130 outputs the position (x, y, z) 131 to the first trained model of the density training/inference section 111 of the optical information training/inference part 110 as three-dimensional position information. Further, the spatial sampling part 135 outputs the observation azimuth (θ, φ) 132 to the second trained model of the optical training/inference part 112 of the optical information training/inference part 110 as azimuth information. Then, the first trained model of the density training/inference section 111 outputs an intermediate representation 1112 to the optical training/inference part 112.

The first trained model of the density training/inference section 111 uses the position (x, y, z) 131 to generate a density 1111 and outputs the density 1111 to the rendering apparatus 200. Further, the second trained model of the optical training/inference part 112 uses the observation azimuth (θ, φ) 132 and the intermediate representation 1112 to generate RGB values 1121 and outputs the RGB values 1121 to the rendering apparatus 200.

The rendering apparatus 200 uses the density 1111 and the RGB values 1121 to generate a pixel of the two-dimensional image 202 corresponding to the information 201 regarding pixels. In this manner, all pixels of the two-dimensional image 202 are generated, and the two-dimensional image 202 is rendered and outputted. The rendered two-dimensional image 202 is sent to the two-dimensional image display apparatus 400. In this manner, a two-dimensional image of the three-dimensional scene 1000 from the free viewpoint 1410 entered by the user is displayed on the two-dimensional image display apparatus 400.

### (3) Configuration and Operation of the Image Generation System of the First Example Embodiment

Next, with reference to FIG. 3, the following describes a configuration and an operation of the image generation system of the first example embodiment. In FIG. 3, elements having the same reference signs as those in FIG. 2 indicate the same elements.

With reference to FIG. 3, the image generation system 10A relating to the present disclosure includes an image generation apparatus 100A, a rendering apparatus 200, a two-dimensional camera (also referred to as a sensor) 300, and a two-dimensional image display apparatus 400. The two-dimensional camera 300 acquires a two-dimensional image of a three-dimensional scene 1000. The image generation apparatus 100A relating to the present disclosure further includes a reflection azimuth calculator 160 and a switch 191 compared to the image generation apparatus 100 of the conventional image generation system 10. The switch 191 outputs information supplied to an L input during training and outputs information supplied to a G input during Further, a GUI input part 140 of the image inference. generation apparatus 100A in the image generation system 10A relating to the present disclosure includes an angle control parameter input section 142.

### (4) Operation of the Image Generation System of the First Example Embodiment During Training

During training of the image generation system of the first example embodiment, the switch 191 of the image generation apparatus 100A in the image generation system 10A relating to the present disclosure shown in FIG. 3 outputs an input supplied to the L input thereof. In other words, an observation azimuth 132 is supplied to the L input of the switch 191 and is outputted from the switch 191 to an optical training/inference part 112 as azimuth information 1911. An operation during training of the first example embodiment is the same as the operation, described with reference to FIG. 2, during training of the conventional image generation system 10, except that the observation azimuth 132 is passed through and outputted from the switch 191 to the optical training/inference part 112 as the azimuth information 1911. Note that the azimuth information 1911 is the same as the observation azimuth 132 during training. Further, it is also possible to use a configuration in which a position 131 and the observation azimuth 132 outputted by a sampler 130 are converted into a position-embedded representation and an azimuth-embedded representation.

### (5) Operation of the Image Generation System of the First Example Embodiment During Inference

With reference to the configuration example of the image generation system 10A relating to the present disclosure shown in FIG. 3, the following describes an example of an operation of the image generation system of the first example embodiment during inference, i.e., an operation when a free-viewpoint two-dimensional image of the three-dimensional scene 1000 is generated.

During inference of the image generation system of the first example embodiment, as an example, a user enters a free viewpoint 1410 as the user's observation viewpoint for the three-dimensional scene 1000 into, for instance, a free viewpoint input section 141 of the GUI (Graphic User Interface) input part 140 of the image generation system 10A relating to the present disclosure shown in FIG. 3. The free viewpoint 1410 supplied to the free viewpoint input section 141 is outputted from the free viewpoint input section 141 to a G input of a switch 190 as a free viewpoint 1411. During inference, the switch 190 outputs the free viewpoint 1411 supplied to the G input to a spatial sampling part 135 of the sampler 130 as an output 1901. Note that the free viewpoint 1411 is the same as the free viewpoint 1410.

The rendering apparatus 200 sends information 201 regarding pixels to be rendered to the sampler 130, and the spatial sampling part 135 generates the position (x, y, z) 131 and the observation azimuth (θ, φ) 132 required to generate a pixel of a two-dimensional image 202 corresponding to the information 201 regarding pixels.

Next, the spatial sampling part 135 of the sampler 130 outputs the position (x, y, z) 131 to a first trained model of a density training/inference section 111 of an optical information training/inference part 110 as three-dimensional position information. Further, the spatial sampling part 135 outputs the observation azimuth 132 to the reflection azimuth calculator 160.

Meanwhile, an angle control parameter 1420 is supplied to the angle control parameter input section 142 of the GUI input part 140 and is outputted from the angle control parameter input section 142 to the reflection azimuth calculator 160 as an angle control parameter 1421. Note that the angle control parameter 1421 is the same as the angle control parameter 1420.

A calculation of the angle control parameter 1421 supplied to the reflection azimuth calculator 160 and the observation azimuth 132 supplied from the spatial sampling part 135 of the sampler 130 is performed, and a calculation output 1601 of the reflection azimuth calculator 160 is supplied to the G input of the switch 191. The calculation output 1601 is outputted from the switch 191 to a second trained model of the optical training/inference part 112 of the optical information training/inference part 110 as the azimuth information 1911. Note that, during inference, the azimuth information 1911 is the same as the calculation output 1601.

When using a configuration in which the position 131 and the observation azimuth 132 outputted by the sampler 130 are converted into a position-embedded representation and a azimuth-embedded representation, respectively, as an example, a reflection azimuth calculator 160 capable of performing a calculation with a azimuth-embedded representation can be used to perform a calculation of an angle control parameter 1421 of the azimuth-embedded representation and a n observation azimuth 132 of the azimuth-embedded representation whereby azimuth information 1911 of the azimuth-embedded representation to be supplied to the optical training/inference part 112 is generated. Further, in the case of using an azimuth-embedded representation, the reflection azimuth calculator 160 may also include an operation such as array concatenation.

Note that operations of the first trained model of the density training/inference section 111, the second trained model of the optical training/inference part 112, and the rendering apparatus 200 are the same as those of the conventional image generation system 10 during inference described with reference to FIG. 2.

When a free-viewpoint two-dimensional image of a three-dimensional scene is generated, a lighting environment and luster in the two-dimensional image can be changed by varying the angle control parameter 1421 supplied to the reflection azimuth calculator 160.

This is because, by supplying the azimuth information 1911 obtained by performing a calculation of the observation azimuth 132 and the angle control parameter 1421 and outputted by the switch 191 to the second trained model of the pre-trained optical training/inference part 112, a viewpoint for generating a free-viewpoint two-dimensional image, i.e., a reflected light when viewed from a different azimuth relative to the free viewpoint, i.e., RGB values (or optical information) 1121 can be extracted from the second trained model of the pre-trained optical training/inference part 112.

Therefore, according to the first example embodiment, there can be provided an image generation apparatus, an image generation method, and a program that contribute to enabling control of a lighting environment and luster in a two-dimensional image when generating a free-viewpoint two-dimensional image of a three-dimensional scene after teacher images have been shot in a fixed lighting environment.

### Second Example Embodiment

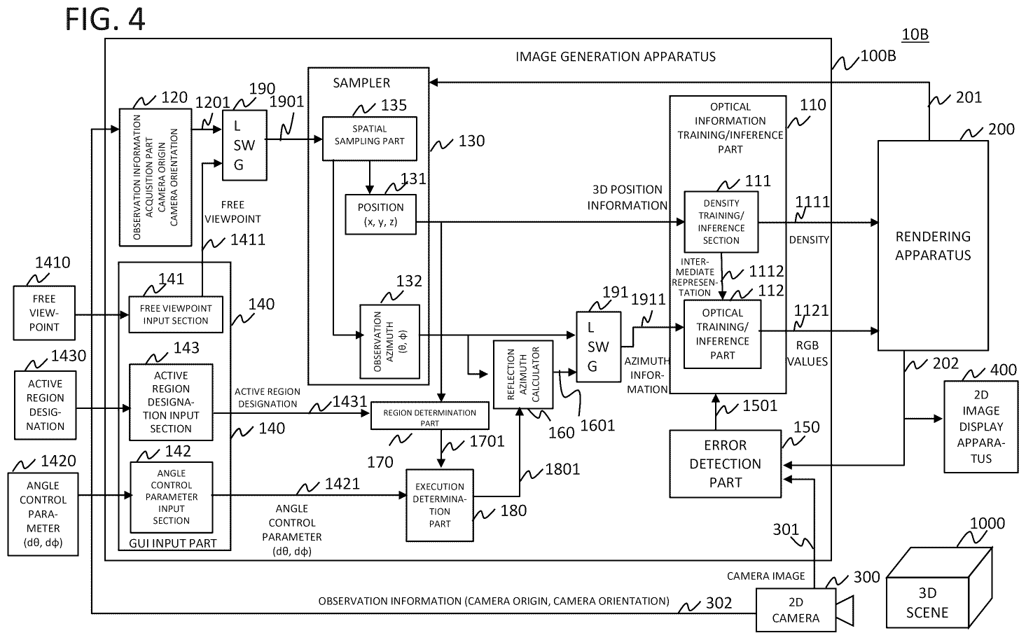

Next, a second example embodiment will be described in detail with reference to the drawings. FIG. 4 is a block diagram illustrating an example of a configuration of an image generation system relating to the present disclosure. In FIG. 4, elements having the same reference signs as those in FIG. 3 indicate the same elements.

With reference to FIG. 4, the image generation system 10B relating to the present disclosure includes an image generation apparatus 100B, a rendering apparatus 200, a two-dimensional camera (also referred to as a sensor) 300, and a two-dimensional image display apparatus 400. The two-dimensional camera 300 acquires a two-dimensional image of a three-dimensional scene 1000. The image generation apparatus 100B relating to the present disclosure further includes a region determination part 170 and an execution determination part 180 to the image generation apparatus 100A relating to the present disclosure shown in FIG. 3. Further, a GUI input part 140 of the image generation apparatus 100B further includes an active region designation input section 143 to the GUI input part 140 of the image generation apparatus 100A shown in FIG. 3.

An operation during training of the second example embodiment is the same as the operation, described with reference to FIG. 3, during training of the first example embodiment. Further, it is also possible to use a configuration in which a position 131 and an observation azimuth 132 outputted by a sampler 130 are converted into a position-embedded representation and an azimuth-embedded representation, respectively.

With reference to the configuration example of the image generation system 10B relating to the present disclosure shown in FIG. 4, the following describes an example of an operation of the image generation system of the second example embodiment during inference, i.e., an operation when a free-viewpoint two-dimensional image of the three-dimensional scene 1000 is generated.

During inference of the image generation system of the second example embodiment, as an example, a user enters a free viewpoint 1410 as the user's observation viewpoint for the three-dimensional scene 1000 into, for instance, a free viewpoint input section 141 of the GUI input part 140 of the image generation system 10B relating to the present disclosure shown in FIG. 4. The free viewpoint 1410 supplied to the free viewpoint input section 141 is outputted from the free viewpoint input section 141 to a G input of a switch 190 as a free viewpoint 1411. During inference, the switch 190 outputs the free viewpoint 1411 supplied to the G input to a spatial sampling part 135 of the sampler 130 as an output 1901. Note that the free viewpoint 1411 is the same as the free viewpoint 1410.

The rendering apparatus 200 sends information 201 regarding pixels to be rendered to the sampler 130, and the spatial sampling part 135 generates the position (x, y, z) 131 and the observation azimuth (θ, φ) 132 required to generate a pixel of a two-dimensional image 202 corresponding to the information 201 regarding pixels.

Next, the spatial sampling part 135 of the sampler 130 outputs the position (x, y, z) 131 to a first trained model of a density training/inference section 111 of an optical information training/inference part 110 as three-dimensional position information. Further, the spatial sampling part 135 outputs the observation azimuth 132 to a reflection azimuth calculator 160.

Meanwhile, an angle control parameter 1420 is supplied to an angle control parameter input section 142 of the GUI input part 140 and is outputted from the angle control parameter input section 142 to the execution determination part 180 as an angle control parameter 1421.

The region determination part 170 outputs an instruction with indication of being outside a region as a determination result 1701 until active region designation 1431 is entered.

As an example, the execution determination part 180 outputs to the reflection azimuth calculator 160 a parameter with which the reflection azimuth calculator 160 does not perform calculation as an output 1801 when an instruction with indication of being outside a region is supplied by the region determination part 170 as the determination result 1701. An example of a parameter with which the reflection azimuth calculator 160 does not perform calculation is zero when the reflection azimuth calculator 160 performs addition or subtraction. Another example is one when the reflection azimuth calculator 160 performs multiplication or division. When receiving such a parameter with which the reflection azimuth calculator 160 does not perform calculation, the reflection azimuth calculator 160 outputs the observation azimuth 132 supplied by the spatial sampling part 135 of the sampler 130 to a G input of a switch 191 as a calculation output 1601.

As another example, the execution determination part 180 may output to the reflection azimuth calculator 160 a particular control code or the like that prevents the reflection azimuth calculator 160 from performing calculation as the output 1801 when an instruction with indication of being outside a region is supplied by the region determination part 170 as the determination result 1701. In this case, the reflection azimuth calculator 160 outputs the observation azimuth 132 supplied by the spatial sampling part 135 of the sampler 130 to the G input of the switch 191 as the calculation output 1601.

The calculation output 1601 is outputted from the switch 191 to a second trained model of an optical training/inference part 112 of the optical information training/inference part 110 as azimuth information 1911. Note that, during inference, the azimuth information 1911 is the same as the calculation output 1601.

When using a configuration in which the position 131 and the observation azimuth 132 outputted by the sampler 130 are converted into a position-embedded representation and a azimuth-embedded representation, respectively, as an example, a reflection azimuth calculator 160 capable of performing a calculation with a azimuth-embedded representation to perform a calculation of an angle control parameter 1421 of the azimuth-embedded representation and an observation azimuth 132 of the azimuth-embedded representation whereby azimuth information 1911 of the azimuth-embedded representation to be supplied to the optical training/inference part 112 is generated. Further, in the case of using an azimuth-embedded representation, the reflection azimuth calculator 160 may also include an operation such as array concatenation. Moreover, when using a position-embedded representation, by using a region determination part 170 capable of making a decision with a position-embedded representation, a determination may be made using an active region 1431 of the position-embedded designation representation.

Note that operations of the first trained model of the density training/inference section 111, the second trained model of the optical training/inference part 112, and the rendering apparatus 200 are the same as those of the conventional image generation system 10 during inference described with reference to FIG. 2.

In this manner, a two-dimensional image of the three-dimensional scene 1000 from the free viewpoint 1411 is generated by the rendering apparatus and displayed on the two-dimensional image display apparatus 400. This two-dimensional image of the three-dimensional scene 1000 from the free viewpoint 1411 displayed on the two-dimensional image display apparatus 400 corresponds to a reconstructed space based on the trained spatial structure.

Further, the user enters an active region designation 1430 into the active region designation input section 143 of the GUI input part 140 on the two-dimensional image of the three-dimensional scene 1000 from the free viewpoint 1411 rendered by the rendering apparatus 200 and displayed on the two-dimensional image display apparatus 400. The entered active region designation 1430 is outputted from the active region designation input section 143 to the region determination part 170 as an active region designation 1431.

The region determination part 170 receives the position (x, y, z) 131 outputted by the sampler 130. The region determination part 170 determines whether or not the position (x, y, z) 131 supplied by the sampler 130 is within an active region designated by the active region designation 1431. When determining that the position (x, y, z) 131 is within the active region designated by the active region designation 1431, the region determination part 170 outputs to the execution determination part 180 an instruction with indication of being inside a region that the position is within the region as the determination result 1701. Further, when determining that the position (x, y, z) 131 is not within the active region designated by the active region designation 1431, the region determination part 170 outputs to the execution determination part 180 an instruction with indication of being outside a region as the determination result 1701. Note that, as an example, a boundary of the region may be considered as within the region. Alternatively, a boundary of the region may be judged as outside the region.

When receiving an instruction with indication of being inside a region from the region determination part 170 as the determination result 1701, the execution determination part 180 outputs the supplied angle control parameter 1421 to the reflection azimuth Note that the angle calculator 160 as the output 1801. control parameter 1421 is the same as the angle control parameter 1420.

A calculation of the output 1801 supplied to the reflection azimuth calculator 160 (i.e., the angle control parameter 1421) and the observation azimuth 132 supplied from the spatial sampling part 135 of the sampler 130 is performed, and the calculation output 1601 of the reflection azimuth calculator 160 is supplied to the G input of the switch 191.

The calculation output 1601 is outputted from the switch 191 to the second trained model of the optical training/inference part 112 of the optical information training/inference part 110 as the azimuth information 1911. Note that, during inference, the azimuth information 1911 is the same as the calculation output 1601.

Note that operations of the first trained model of the density training/inference section 111, the second trained model of the optical training/inference part 112, and the rendering apparatus 200 are the same as those of the conventional image generation system 10 during inference described with reference to FIG. 2.

In this manner, by having the rendering apparatus 200 render again a two-dimensional image of the three-dimensional scene from the free viewpoint 1411, it is possible to generate a two-dimensional image of the three-dimensional scene from the free viewpoint 1411 while applying the angle control parameter 1421 to a particular region.

When a free-viewpoint two-dimensional image of a three-dimensional scene is generated, a lighting environment and luster in the two-dimensional image can be changed by varying the angle control parameter 1421 supplied to the reflection azimuth calculator 160 as the output 1801 via the execution determination part 180.

This is because, by supplying the azimuth information 1911 obtained by performing a calculation of the observation azimuth 132 and the angle control parameter 1421 and outputted by the switch 191 to the second trained model of the pre-trained optical training/inference part 112, a viewpoint for generating a free-viewpoint two-dimensional image, i.e., a reflected light when viewed from a different azimuth relative to the free viewpoint, i.e., RGB values (or optical information) 1121 can be extracted from the second trained model of the pre-trained optical training/inference part 112.

Further, when a free-viewpoint two-dimensional image of a three-dimensional scene is generated, a lighting environment and luster can be changed only for a particular designated region in the two-dimensional image by designating an active region to which the angle control parameter 1421 is applied and applying the angle control parameter 1421 only to the particular active region.

Note that, although the user designates an active region with the active region designation 1430 in the description above, a partial region including a portion clicked on with a pointing device or the like may be automatically designated using an automatic selection function or tool, etc., on a free viewpoint two-dimensional image of a three-dimensional scene initially rendered by the rendering apparatus. In this case, for the automatically designated region, by having the rendering apparatus 200 re-render the free-viewpoint two-dimensional image of the three-dimensional scene with the angle control parameter 1421 applied, a lighting environment and luster can be changed only for a particular region in the free-viewpoint two-dimensional image of the three-dimensional scene.

Further, when the user designates the entire area of a free-viewpoint two-dimensional image of a three-dimensional scene as an active region using the active region designation 1430, a generated free-viewpoint two-dimensional image of the three-dimensional scene having the supplied angle control parameter 1421 applied thereto is the same as a free-viewpoint two-dimensional image of the three-dimensional scene generated in the first example embodiment. Further, the user may enter a set of the angle control parameter 1420 and the active region designation 1430 for each of a plurality of regions in a free-viewpoint two-dimensional image of a three-dimensional scene. For instance, the GUI input part 140 may store these sets in a memory thereof and output sets of the angle control parameters 1421 and the active region designations 1431 stored in the memory, applying a discrete and corresponding angle control parameter 1421 to each of the plurality of regions designated by the active region designations 1431.

As described above, according to the second example embodiment, there can be provided an image generation apparatus, an image generation method, and a program that contribute to enabling control of a lighting environment and luster only for a particular designated region of a two-dimensional image when generating a free-viewpoint two-dimensional image of a three-dimensional scene after teacher images have been shot in a fixed lighting environment.

### Third Example Embodiment

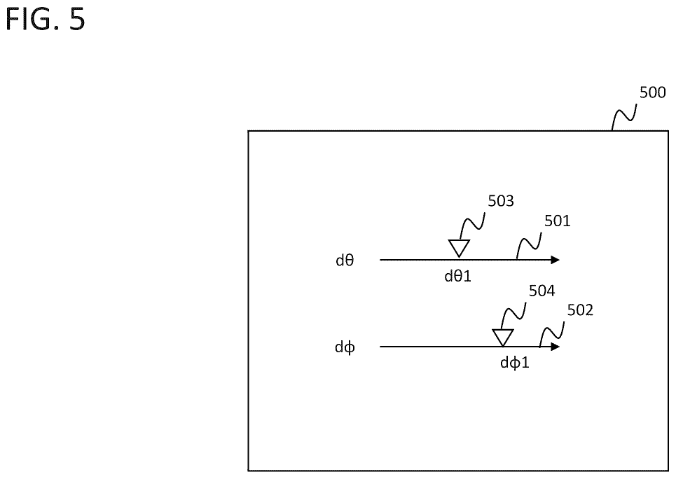

Next, a third example embodiment will be described in detail with reference to a drawing. FIG. 5 is a drawing illustrating an example of a configuration of an input screen of an angle control parameter input section of a GUI input part of an image generation apparatus relating to the present disclosure.

With reference to FIG. 5, the input screen 500 of the angle control parameter input section 142 of the GUI input part 140 displays a dθ axis 501 of dθ of an angle control parameter 1420, a dφ axis 502 of dφ of the angle control parameter 1420, and sliders 503 and 504. For dθ and dφ of the angle control parameter 1420, values dθ1 and dφ1 are selected by moving the sliders 503 and 504 on the dθ axis 501 and the dφ axis 502, respectively, using a pointing device or the like. As a result, the angle control parameter 1420 can be entered via the angle control parameter input section 142.

### Fourth Example Embodiment

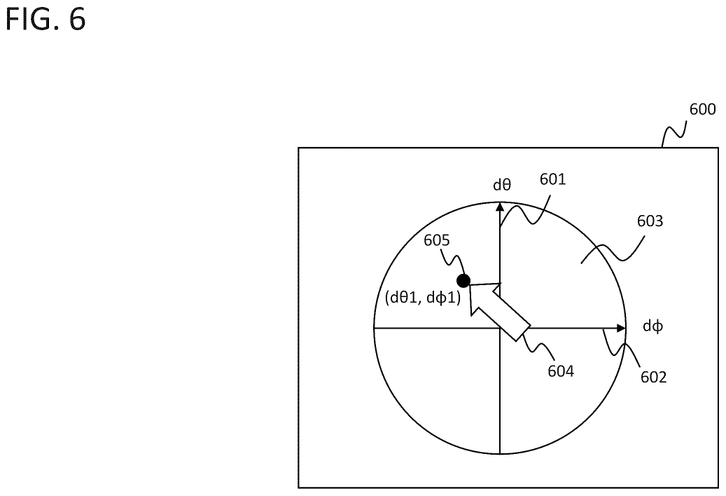

Next, a fourth example embodiment will be described in detail with reference to a drawing. FIG. 6 is a drawing illustrating an example of a configuration of an input screen of an angle control parameter input section of a GUI input part of an image generation apparatus relating to the present disclosure.

With reference to FIG. 6, the input screen 600 of the angle control parameter input section 142 of the GUI input part 140 displays a dθdφ plane 603 of an angle control parameter 1420. As an example, the dθdφ plane 603 may display a color map indicating each position on the dθdφ plane 603 by color.

On the dθdφ plane 603, a dθ axis 601 of dθ of the angle control parameter 1420 and a dφ axis 602 of dφ of the angle control parameter 1420 are shown. For dθ and dφ of the angle control parameter 1420, values dθ1 and dφ1 are selected by selecting, for instance, by pointing at and clicking on a point 605 using a pointing device or the like on the dθdφ plane 603. As a result, a selected angle control parameter 1420 can be entered via the angle control parameter input section 142.

### Fifth Example Embodiment

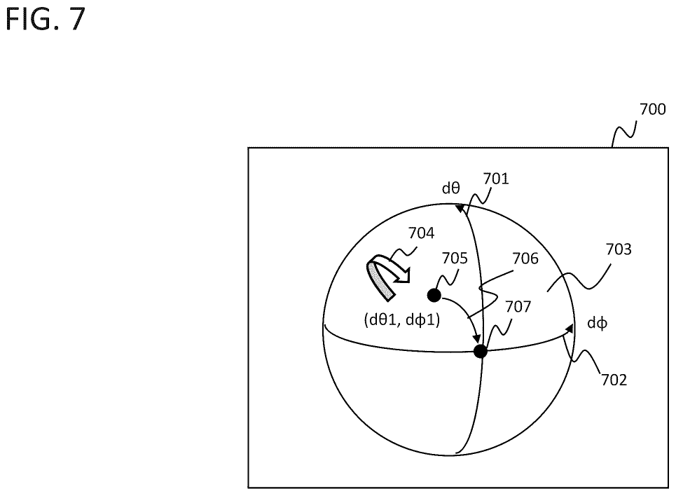

Next, a fifth example embodiment will be described in detail with reference to a drawing. FIG. 7 is a block diagram illustrating an example of a configuration of an input screen of an angle control parameter input section of a GUI input part of an image generation apparatus relating to the present disclosure.

With reference to FIG. 7, on the input screen 700 of the angle control parameter input section 142 of the GUI input part 140, a ball 703 showing a dθdφ region of the angle control parameter 1420 on the surface thereof is displayed. As an example, the ball 703 showing the dθdφ region may display a color map indicating each position on the surface of the ball 703 showing the dθdφ region by color.

On the surface of the ball 703 showing the dθdφ region, a dθ axis 701 of dθ of the angle control parameter 1420 and a dφ axis 702 of dφ of the angle control parameter 1420 are shown. The dθ axis 701 and the dφ axis 702 remain fixed, even when the ball 703 rotates. On the display screen, values dθ1 and dφ1 indicated by a point 705 can be selected by performing rotation 704 using a finger or the like on the ball 703 and aligning the point 705 with, for instance, an origin 707 of the dθ axis 701 and the dφ axis 702. As a result, the angle control parameter 1420 can be entered via the angle control parameter input section 142.

As described above, according to the third to the fifth example embodiments, the GUI input part 140 is able to enter the angle control parameter 1420.

### Sixth Example Embodiment

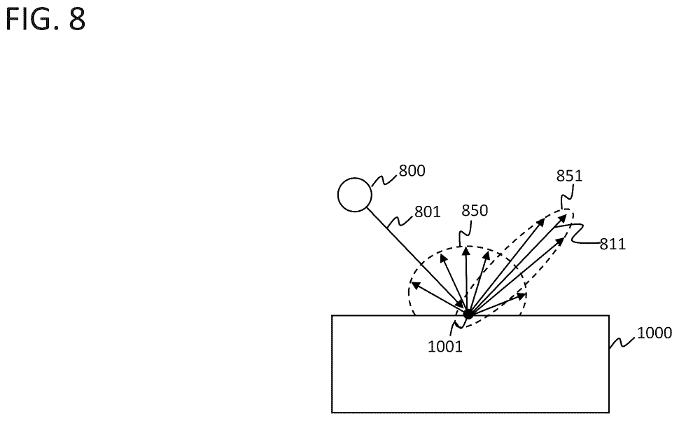

Next, a sixth example embodiment will be described in detail with reference to the drawings. FIG. 8 is a drawing schematically illustrating an example of information obtained by the optical training/inference part 112 of the optical information training/inference part 110 relating to the present disclosure shown in FIG. 3. With reference to FIG. 8, a three-dimensional scene 1000 is illuminated by a light source 800, with incident light 801 reaching a reflection position 1001 of the three-dimensional scene 1000. Note that, although the reflection position 1001 is shown as a black circle, this is merely a schematic representation of the position and does not imply the existence of an object represented by the black circle.

The incident light 801 reflects on the reflection position 1001. The reflected light is divided into isotropic components, schematically indicated by arrows within an area enclosed by a dashed line 850, and total reflection components, schematically indicated by arrows within an area enclosed by a dashed line 851. An azimuth in which the magnitude of the reflected light among the total reflection components reaches a peak is referred to as a reflection peak azimuth 811.

Of the information obtained by the optical training/inference part 112, a reflected light component in the reflection peak azimuth 811 is crucial for obtaining luster in a two-dimensional image rendered by the rendering apparatus 200. Therefore, it is essential that teacher to images used train the optical training/inference part 112 to generate the second trained model include a significant amount of reflected light components in the reflection peak azimuth 811.

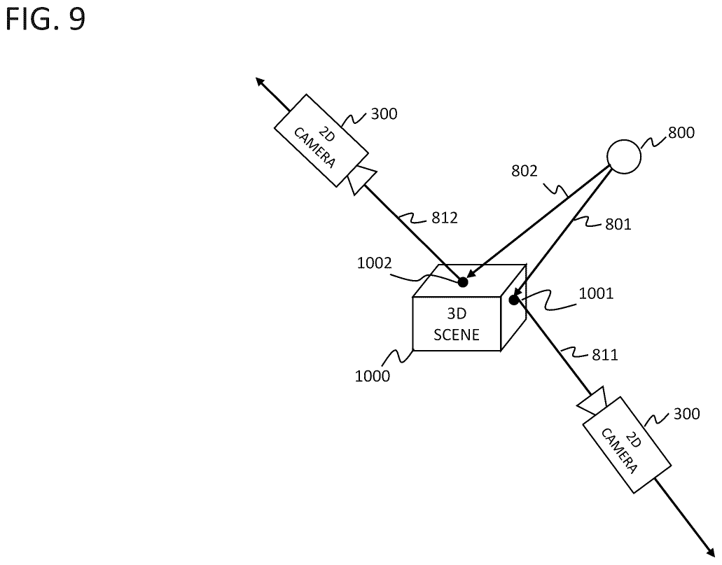

FIG. 9 is a drawing schematically illustrating an example of a method for shooting a teacher image relating to the present disclosure. In FIG. 9, elements having the same reference signs as those in FIG. 8 indicate the same elements. When a two-dimensional image that includes the reflection position 1001 is shot as a teacher image, the two-dimensional camera 300 shown in FIG. 3 shoots the two-dimensional image that includes the reflection position 1001 from an azimuth that matches the reflection peak azimuth 811 of the total reflection components irradiated from the light source 800 and reflected at the reflection position 1001. Further, the two-dimensional camera 300 shown in FIG. 3 shoots a two-dimensional image that includes a reflection position 1002 from an azimuth that matches a reflection peak azimuth 812 of total reflection components irradiated from the light source 800 and reflected at the reflection position 1002.

By shooting a two-dimensional image as a teacher image with the two-dimensional camera 300 in this manner and using to it train the optical training/inference part 112, it becomes possible to generate a free-viewpoint two-dimensional image of a three-dimensional scene with higher reproducibility.

While each example embodiment of the present invention has been described, it is to be understood that the present invention is not limited to the example embodiments above and that further modifications, replacements, and adjustments may be added without departing from the basic technical concept of the present invention. For instance, the network configuration, the configuration of each element, and the expression of each message shown in each drawing are examples to facilitate understanding of the present invention and are not limited to the configurations shown in these drawings. Further, “A and/or B” signifies at least one of A and B.

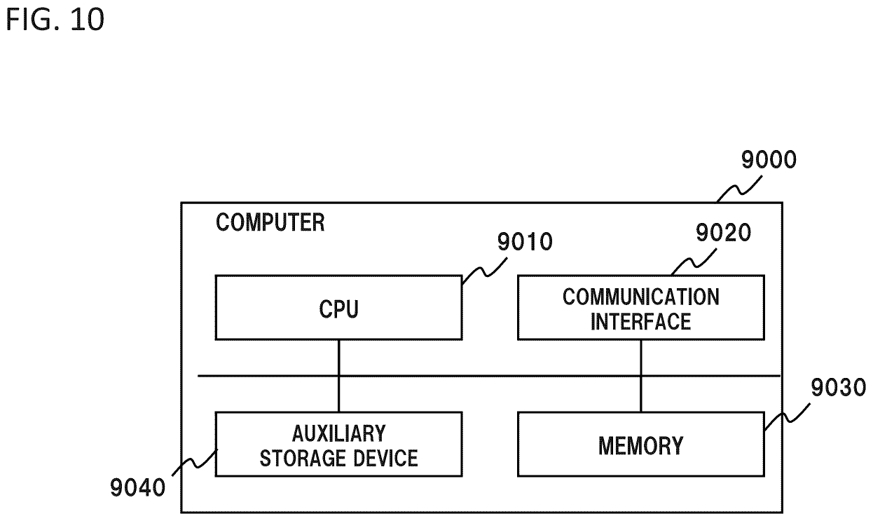

Further, the procedures described in the first to the sixth example embodiments above can be implemented by a program causing a computer (9000 in FIG. 10) that functions as the image generation apparatus relating to the present invention to realize the functions thereof. FIG. 10 illustrates such a computer configured to include a CPU (Central Processing Unit) 9010, a communication interface 9020, a memory 9030, and an auxiliary storage device 9040. In other words, the CPU 9010 in FIG. 10 executes a program that controls the image generation apparatus, updating each calculation parameter held by the auxiliary storage device 9040 thereof.

The memory 9030 is a RAM (Random Access Memory), a ROM (Read-Only Memory), and the like.

In other words, each part (each processing means or function) of the image generation apparatuses described in the first to the sixth example embodiments above can be realized by a computer program causing the processor of the computer to execute each of the processes described above using the hardware thereof.

Finally, preferred modes of the present invention will be summarized.

### Mode 1

An image generation apparatus may generates a free-viewpoint two-dimensional image of a three-dimensional scene, a spatial structure and information on optics of which have been trained,

The image generation apparatus may include:
a pre-trained optical training/inference part; and
a reflection azimuth calculator, wherein

The optical training/inference part of the image generation apparatus receives azimuth information and extracts optical information by utilizing at least the azimuth information.

The reflection azimuth calculator of the image generation apparatus may receive an angle control parameter as an input, perform a calculation of an observation azimuth and the angle control parameter to at least a partial region within a reconstructed space based on the trained spatial structure to generate the azimuth information, and output the azimuth information to the optical training/inference part.

### Mode 2

In the image generation apparatus according to Mode 1, it is preferable that the angle control parameter designates an amount of angle deviation from a reference angle.

### Mode 3

In the image generation apparatus according to Mode 1, it is preferable that the angle control parameter is inputted from outside.

### Mode 4

In the image generation apparatus according to Mode 1, it is preferable that the angle control parameter is inputted from outside via a graphic user interface.

### Mode 5

In the image generation apparatus according to Mode 1, it is preferable that an active region designation that designates the partial region is inputted from outside.

### Mode 6

It is preferable that the image generation apparatus according to Mode 5 further includes a region determination part that determines the partial region on the basis of the active region designation.

### Mode 7

In the image generation apparatus according to Mode 1, it is preferable that the partial region is determined automatically.

### Mode 8

In the image generation apparatus according to Mode 1, it is preferable that the calculation is addition of the observation azimuth and the angle control parameter.

### Mode 9

An image generation method performed by a computer of an image generation apparatus may generate a free-viewpoint two-dimensional image of a three-dimensional scene, a spatial structure and information on optics of which have been trained may include:
receiving azimuth information and extracting optical information by utilizing at least the azimuth information through a pre-trained optical training/inference part.

The image generation method performed by the computer may include:
receiving an angle control parameter as an input; and performing a calculation of an observation azimuth and the angle control parameter to at least a partial region within a reconstructed space based on the trained spatial structure to generate the azimuth information.

### Mode 10

A program, may, cause a computer of an image generation apparatus that a free-viewpoint generates two-dimensional image of a three-dimensional scene, a spatial structure and information on optics of which have been trained, to execute processings of:
receiving azimuth information and extracting optical information by utilizing at least the azimuth information through a pre-trained optical training/inference part.

The program, may, cause a computer to execute processings of:
receiving an angle control parameter as an input; and performing a calculation of an observation azimuth and the angle control parameter to at least a partial region within a reconstructed space based on the trained spatial structure to generate the azimuth information.

Further, as Mode 1, Modes 9 to 10 can be expanded into Modes 2 to 8.

### Mode 11

An image generation apparatus, generating a free-viewpoint two-dimensional image of a three-dimensional scene, a spatial structure and information on optics of which have been trained, the image generation apparatus comprising:
a pre-trained optical training/inference section; and
a reflection azimuth calculator, wherein
the optical training/inference section receives azimuth information and extracts optical information by utilizing at least the azimuth information,
the reflection azimuth calculator receives an angle control parameter as an input, performs a calculation of an observation azimuth and the angle control parameter to at least a partial region within a reconstructed space based on the trained spatial structure to generate the azimuth information, and outputs the azimuth information to the optical training/inference section, and
the angle control parameter is inputted by a GUI input part.

### Mode 12

The image generation apparatus according to Mode 11, wherein the GUI input part displays a slider that designates an angle control parameter and accepts an angle control parameter indicated by the slider as an input.

### Mode 13

The image generation apparatus according to Mode 11, wherein the GUI input part displays an angle control parameter plane that indicates an angle control parameter and accepts as an input an angle control parameter corresponding to a position on the angle control parameter plane by designating the position with a pointing device.

### Mode 14

The image generation apparatus according to Mode 11, wherein the GUI input part displays a ball including a surface indicating an angle control parameter and accepts as an input an angle control parameter indicated by a point on the surface of the ball that is aligned with a predetermined origin on the surface of the ball by rotating the ball.

### Mode 15

An image generation method, in which a computer of an image generation apparatus executes the processes of Modes 11 to 13.

### Mode 16

A program, causing a computer of an image generation apparatus to execute the processes of Modes 15.

### Mode 17

The image generation apparatus according to Mode 1, training a spatial structure and information on optics using an image including a two-dimensional image shot according to a reflection peak azimuth of each point in a three-dimensional scene from a light source as a teacher image.

### Mode 18

An image generation method in which a computer of an image generation apparatus executes the process of Mode 17.

### Mode 19

A program, causing a computer of an image generation apparatus to execute the process of Mode 18.

Further, the disclosure of Patent Literature cited above is incorporated herein in its entirety by reference thereto. It is to be noted that it is possible to modify or adjust the example embodiments or examples within the scope of the whole disclosure of the present invention (including the Claims) and based on the basic technical concept thereof. Further, it is possible to variously combine or select a wide variety of the disclosed elements (including the individual elements of the individual claims, the individual elements of the individual example embodiments or examples, and the individual elements of the individual figures) within the scope of the whole disclosure of the present invention. That is, the present invention of course includes any types of variations and modifications to be done by a skilled in the art according to the whole disclosure including the claims, and the technical concept of the present invention. In particular, with respect to the numerical ranges described herein, any numerical values or small range(s) included in the ranges should be construed as being expressly described even if not particularly mentioned. In addition, as needed and based on the gist of the present invention, partial or entire use of the individual disclosed matters in the above literatures that have been referred to in combination with what is disclosed in the present application should be deemed to be included in what is disclosed in the present application, as part of the disclosure of the present invention.

### REFERENCE SIGNS LIST

10, 10A, 10B: image generation system
100, 100A, 100B: image generation apparatus
101: image generation apparatus
102: optical training/inference part
103: reflection azimuth calculator
110: optical information training/inference part
111: density training/inference section
112: optical training/inference part
120: observation information acquisition part
130: sampler
131: position
132: observation azimuth
135: spatial sampling part
140: GUI input part
141: free viewpoint input section
142: angle control parameter input section
143: active region designation input section
150: error detection part
160: reflection azimuth calculator
170: region determination part
180: execution determination part
190, 191: switch
200: rendering apparatus
300: two-dimensional camera (sensor)
400: two-dimensional image display apparatus
500, 600, 700: input screen
800: light source
1000: three-dimensional scene
9000: computer
9010: CPU
9020: communication interface
9030: memory
9040: auxiliary storage device

What is claimed is:

1. An image generation apparatus, generating a free-viewpoint two-dimensional image of a three-dimensional scene, a spatial structure and information on optics of which have been trained, the image generation apparatus comprising:
at least a processor; and
a memory in circuit communication with the processor,
wherein the processor is configured to execute program instructions stored in the memory to implement: a pre-trained optical training/inference part and a reflection azimuth calculator,
receiving azimuth information and extracting optical information by utilizing at least the azimuth information through the optical training/inference part,
receiving an angle control parameter as an input, and
performing a calculation of an observation azimuth and the angle control parameter to at least a partial region within a reconstructed space based on the trained spatial structure to generate the azimuth information, and outputs the azimuth information to the optical training/inference part.

2. The image generation apparatus according to claim 1, wherein the angle control parameter designates an amount of angle deviation from a reference angle.

3. The image generation apparatus according to claim 1, wherein the angle control parameter is inputted from outside

4. The image generation apparatus according to claim 1, wherein the angle control parameter is inputted from outside via a graphic user interface.

5. The image generation apparatus according to claim 1, wherein an active region designation that designates the partial region is inputted from outside.

6. The image generation apparatus according to claim 5, wherein the processor is configured to execute the program instructions to perform:
determining the partial region on the basis of the active region designation.

7. The image generation apparatus according to claim 1, wherein the partial region is determined automatically.

8. The image generation apparatus according to claim 1, wherein the calculation is addition of the observation azimuth and the angle control parameter.

9. An image generation method performed by a computer of an image generation apparatus that generates a free-viewpoint two-dimensional image of a three-dimensional scene, a spatial structure and information on optics of which have been trained, comprising:
receiving azimuth information and extracting optical information by utilizing at least the azimuth information through a pre-trained optical training/inference part;
receiving an angle control parameter as an input; and
performing a calculation of an observation azimuth and the angle control parameter to at least a partial region within a reconstructed space based on the trained spatial structure to generate the azimuth information.

10. The image generation method according to claim 9, wherein the angle control parameter designates an amount of angle deviation from a reference angle.

11. The image generation method according to claim 9, wherein the angle control parameter is inputted from outside.

12. The image generation method according to claim 9, wherein the angle control parameter is inputted from outside via a graphic user interface.

13. The image generation method according to claim 9, wherein an active region designation that designates the partial region is inputted from outside.

14. The image generation method according to claim 13, further comprising:
determining the partial region on the basis of the active region designation.

15. A computer-readable non-transitory recording medium recording a program, the program, causing a computer of an image generation apparatus that generates a free-viewpoint two-dimensional image of a three-dimensional scene, a spatial structure and information on optics of which have been trained, to execute processings of:
receiving azimuth information and extracting optical information by utilizing at least the azimuth information through a pre-trained optical training/inference part;
receiving an angle control parameter as an input; and
performing a calculation of an observation azimuth and the angle control parameter to at least a partial region within a reconstructed space based on the trained spatial structure to generate the azimuth information.

16. The recording medium according to claim 15, wherein the angle control parameter designates an amount of angle deviation from a reference angle.

17. The recording medium according to claim 15, wherein the angle control parameter is inputted from outside.

18. The recording medium according to claim 15, wherein the angle control parameter is inputted from outside via a graphic user interface.

19. The recording medium according to claim 15, wherein an active region designation that designates the partial region is inputted from outside.

20. The recording medium according to claim 19, the program, causing a computer to execute processing of:
determining the partial region on the basis of the active region designation.
